(19) United States
(12) Patent Application Publication
(10) Pub. No.: US 2021/0239367 A1
(43) Pub. Date: Aug. 5, 2021

(54) A METHOD OF SEPARATION BY SOLIDIFICATION USED IN ABSORPTION HEATING COOLING SYSTEMS WORKING WITH CRYSTALLIZATION / FREEZING / ICING METHODS

(71) Applicant: MAXEFF TEKNOLOJI ANONIM SIRKETI, Istanbul (TR)

(72) Inventor: Murat ISLER, Istanbul (TR)

(21) Appl. No.: 17/050,577

(22) PCT Filed: Apr. 11, 2019
(86) PCT No.: PCT/TR2019/050234

§ 371 Date: Oct. 26, 2020

(30) Foreign Application Priority Data
Apr. 27, 2018 (TR) 2018/06012

(51) Int. Cl. F25B 15/02; F25B 29/00

(52) U.S. Cl. CPC F25B 15/02; F25B 37/00; F25B 29/006

(57) ABSTRACT

An absorption heating and cooling system having an absorber, which allows the gaseous refrigerant to be absorbed by the absorbent, condensed by its heat, and thus the liquefaction of the gaseous refrigerant while the heating operation takes place, and an evaporator that allows the liquid refrigerant to evaporate by heating and thus cooling process to be carried out, wherein a separation unit using a method of separation by solidification employed which works through the icing/crystallization/freezing methods and which enables the separation the refrigerant-absorbent mixture.

### TECHNICAL FIELD

The invention relates generally to a method of separation by solidification used in heating and cooling systems and works with crystallization/freezing/icing methods.

In particular, the invention relates to the integration of absorption systems and separation systems, which work by crystallization/freezing/icing, to reduce energy consumption in conventional absorption cooling and heating systems operating on a distillation-like basis.

### PRIOR ART

Nowadays, various methods are being used in cooling and heating systems. In addition to the use of conventional boiler systems for heating, there are also systems such as heat pumps. When we examine the cooling systems in general, the vapor compression cycles and the use of absorption or adsorption systems are available. The energy consumed by these systems is relatively high.

In absorption cooling and heating systems of the current technique, systems for separating the refrigerant and the absorbent from each other and purifying the refrigerant are generally encountered, namely the distillation, the systems in which the refrigerant is evaporated and then condensed, the experiments with membrane type separation are available. The energy consumption in these systems is relatively high.

An exemplary absorption cooling system flow in the current technique is as follows: the low-pressure gaseous refrigerant which evaporated in the evaporator passes to the absorber, the refrigerant, which has given some of the heat it has in the heat exchanger, is absorbed by the high-concentration refrigerant-absorbent mixture, the condensation occurs during absorption and the refrigerant passing through the liquid state from a gaseous state and the energy on it is transferred to the tower water from the cooling tower. The high concentration refrigerant-absorbent mixture, together with the refrigerant it absorbed, is decreased in concentration and turn into a low concentration refrigerant-absorbent mixture and is directed to the heat exchanger by means of a pump from the absorber. A low concentration refrigerant-absorbent mixture that passes through the heat recovery exchanger and heats up reaches the generator. The low concentration refrigerant-absorbent mixture is heated by the heat coming from the heat source in the generator and while some part of the refrigerant is vaporized and directed to the condenser, the low concentration refrigerant-absorbent mixture becomes the high concentration refrigerant-absorbent mixture and then exits the generator and goes to the heat recovery exchanger. While the refrigerant condensed in the condenser becomes liquid, the enthalpy of gasification is transferred to the water coming from the cooling tower. The refrigerant in liquid-state passes through the expansion valve and reaches the evaporator. By taking heat on it, the refrigerant evaporates in the evaporator and the cycle is completed.

As seen in the applications in the current technique, the energy consumption and installation costs are high. It also has a complex structure and volumetrically occupies a lot of space.

The technical content of the patent application numbered as TR2010/07984, which was found in the patent survey of the prior art, relates to an energy conversion system with a multi-stage absorption cooling machine or absorption heat pump. All of the multistage absorption machines have at least one high-pressure generator in which the refrigerant at the highest temperature level in the machine is removed from the sorbent material, and at least one medium-pressure generator in which the refrigerant is removed from the sorbent material, and wherein the medium-pressure generator is operated by condensation temperature of refrigerant vapor extracted from the high-pressure generator. This heat transfer takes place with a first thermal connection unit. Thanks to a second thermal connection unit, additional drive temperature at medium temperature level or several drive temperatures with different average temperature levels are connected to the first thermal connection unit.

As a result, improvements are made in the absorption heating and cooling systems with the developing technology, so new structures are needed to eliminate the disadvantages mentioned above and to bring solutions to the existing systems.

### DESCRIPTION OF THE INVENTION

The present invention relates to an absorption heating and cooling systems that meets the above-mentioned requirements, eliminates all disadvantages and brings some additional advantages.

The main purpose of the invention is to reduce the energy consumption in heating and cooling systems, in these days when the importance of energy efficiency is increasing and energy prices are rising.

Another purpose of the invention is to provide the integration of absorption systems and separation systems, which work by crystallization/freezing/icing, to reduce energy consumption in conventional absorption cooling and heating systems operating on a distillation-like basis.

Another purpose of the invention is to prevent financial losses by reducing energy losses.

Another purpose of the invention is to provide economic profit through the completion of the cycle without the use of many components currently used in heating and cooling systems.

Another purpose of the invention is that it is small in volume because many components in heating and cooling systems are not used.

In order to realize all the advantages mentioned above and to be understood in detail from the description below, the present invention relates to the absorption heating and cooling system consisting of an absorber, which allows the gaseous refrigerant to be absorbed by the absorbent, condensed by its heat, and thus the liquefaction of the gaseous refrigerant while the heating operation takes place, and an evaporator that allows the liquid refrigerant to evaporate by heating and cooling process to be carried out, comprising a separation unit where separation with solidification method is used and the mixture of refrigerant-absorbent is separated through icing/crystallization/freezing methods.

The structural and characteristic features and all advantages of the invention outlined in the drawings below and in the detailed description made by referring these figures will be understood clearly. Therefore, the evaluation should be made considering these figures and detailed explanations.

### BRIEF DESCRIPTION OF THE FIGURES

In order to be able to understand the advantages of the present invention together with the additional elements, it is necessary to evaluate it with the figures explained below.

FIG. 1 Represents the table showing the separation method of the invention used in absorption heating and cooling systems.

FIG. 2 Is the schematic view of the process steps of the separation method used in absorption heating and cooling systems.

### REFERENCE NUMBERS

100—Absorption heating and cooling system
101—Absorber
102—Separation unit
103—Evaporator
104—Low concentration refrigerant absorbent mixture
105—High concentration refrigerant absorbent mixture
106—Liquid refrigerant
107—Gaseous refrigerant
A—Evaporation of refrigerant
B—Condensation and mixture of the refrigerant and absorbent
B—Separation of the refrigerant and absorbent

### DETAILED DESCRIPTION OF THE INVENTION

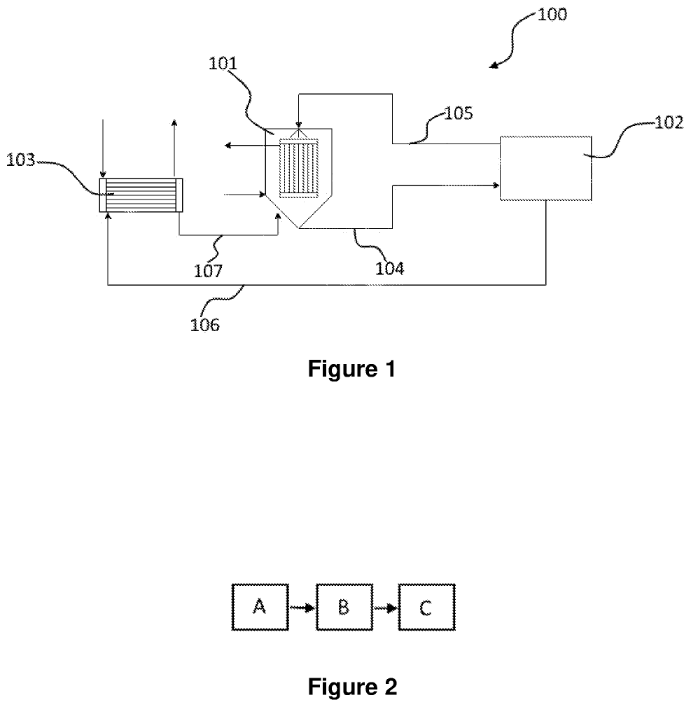

FIG. 1 represents the table showing the separation method of the invention used in absorption heating and cooling systems (100). The invention enables to reduce the energy consumption in heating and cooling systems in these days when the importance of energy efficiency is increasing and energy prices are rising.

The invention comprises the absorber (101) which allows gaseous refrigerant (107) to liquefy while the heating process is carried out and the gaseous refrigerant (107) is absorbed by the absorbent and condensed giving up its heat. The evaporator (103) enables the evaporation of the liquid refrigerant (106) by heating and provides the cooling process to take place. There is a separation unit (102) using a method of separation by solidification employed which works through the icing/crystallization/freezing methods and which enables the separation the refrigerant-absorbent mixture. A refrigerant-absorbent mixture to be separated in the said separation unit (102) is preferred usually as a low concentration refrigerant-absorbent mixture (104).

FIG. 2 is the schematic view of the process steps of the separation method used in absorption heating and cooling systems (100). In the evaporator (103), the liquid refrigerant (106) is gasified by taken heat and the cooling process is carried out (A).

Evaporated refrigerant (107) is absorbed in the gaseous state by the high concentration refrigerant-absorbent mixture through the absorber (101), thereby transferring its energy to give off heat and passes to the liquid phase (B). Once the low concentration refrigerant-absorbent mixture (104) has been formed, the liquid refrigerant (106) is directed to the evaporator (103) by separating the liquid refrigerant in the separation unit (102) using the different freezing/icing/crystallization method, while the high concentration refrigerant-absorbent mixture (105) is directed to the absorber (101) (C). The cycle is then completed when the refrigerant (106) evaporated in the evaporator (103) has carried out the cooling process and passed to the absorber (101).

In relation to the crystallization/freezing processes used in the mentioned separation method, there are examples like the crystallization/freezing methods with evaporation, crystallization/freezing methods with vacuum, crystallization/freezing/icing methods with the use of different liquid refrigerant, direct or indirect crystallization/freezing/icing methods, crystallization/freezing/icing methods with eutectic freezing, crystallization/freezing/icing methods with film freezing system, crystallization/freezing/icing methods with progressive freezing desalination, together with the examples of crystallization, acceleration, dimension formation with ultrasound and so on.

In the invention, various refrigerants can be employed in the same system. Also, different pairs of refrigerant—absorbent types can be used. It may be possible to employ membranes considering the further purification of the refrigerant. The number of absorber (101) can be increased or the temperature difference can be increased with the use of absorber in series. As it can produce steam with the absorber (101), it is possible that the steam produced will be directed to another absorber or system. Also, any sorbent product, such as adsorbent, may be used instead of the absorbent.

The number of evaporators (103) can be increased and heat recovery systems can be added between absorber (101). Expansion valve application in various numbers and types can be added to the system. It is possible to operate at different pressures and/or temperatures. Expansion valve can be added in order to create a pressure difference in the system and control the flow rate. In the evaporator (103), the temperature of the refrigerant at the same pressure can be changed by adding different compounds to the refrigerant.

1. An absorption heating and cooling system comprising an absorber, which allows the gaseous refrigerant to be absorbed by an absorbent, condensed by giving up its heat, and thus the liquefaction of the gaseous refrigerant while the heating operation takes place, and an evaporator that allows liquid refrigerant to evaporate by taking heat and thus cooling process to be carried out, the system further comprising:
a separation unit using a method of separation by solidification employed which works through the icing/crystallization/freezing methods and which enables the separation of the refrigerant-absorbent mixture.

2. A separation method in a absorption heating and cooling system comprising the process steps of vaporization of liquid refrigerant by taking heat in an evaporator, and realization of the cooling process, and the absorption of evaporated refrigerant in the gaseous state by an absorber through the high concentration refrigerant-absorbent mixture, thereby transferring its energy to heat it and turning into the liquid phase, wherein:
once the low concentration refrigerant-absorbent mixture has been formed, the liquid refrigerant is directed to the evaporator by separating the liquid refrigerant in the separation unit using the different freezing/icing/crystallization method, while the high concentration refrigerant-absorbent mixture is directed to the absorber.
